(19) United States
(12) Patent Application Publication
(10) Pub. No.: US 2013/0274021 A1
(43) Pub. Date: Oct. 17, 2013

(54) COMPUTING PLATFORM FOR SUPPORTING MASSIVELY MULTI-PLAYER ONLINE GAMES

(71) Applicant: METEOR ENTERTAINMENT, INC., Seattle, WA (US)

(72) Inventors: Sarah Novotny, Seattle, WA (US); Nicholas Herring, Seattle, WA (US); Cyrus Durgin, Seattle, WA (US)

(73) Assignee: Meteor Entertainment, Inc., Seattle, WA (US)

(21) Appl. No.: 13/797,897

(22) Filed: Mar. 12, 2013

Related U.S. Application Data
(60) Provisional application No. 61/622,740, filed on Apr. 11, 2012.
(60) Provisional application No. 61/718,686, filed on Oct. 25, 2012.

(51) Int. Cl. A63F 13/12

(52) U.S. Cl. CPC A63F 13/12
USPC 463/42

(57) ABSTRACT

A computing platform, system, and method for providing a massively multi-player online game (MMO, MMOG) is described. In some implementations, the platform provides an abstraction layer between client devices associated with players of a game and computing resources, such as cloud-based resources, that support and provide the game to the players.

### CROSS REFERENCE TO RELATED APPLICATIONS

This application is related to, and claims the benefit of, U.S. Provisional Patent Application No. 61/622,740, titled CLOUD-BASED GAMING PLATFORM (filed Apr. 11, 2012), and U.S. Provisional Patent Application No. 61/718,686, titled MODIFYING USE OF RESOURCES WITHIN A CLOUD-BASED GAMING PLATFORM (filed Oct. 25, 2012), each of which is herein incorporated by reference in its entirety. This application is related to U.S. patent application Ser. No. ______, titled MODIFYING USE OF RESOURCES WITHIN A CLOUD-BASED GAMING PLATFORM (filed Mar. 12, 2013, Attorney Docket No. 876908002US), and U.S. patent application Ser. No. ______, titled A COMPUTING PLATFORM FOR SUPPORTING MASSIVELY MULTI-PLAYER ONLINE GAMES (filed Mar. 12, 2013, Attorney Docket No. 876908003US), each of which is herein incorporated by reference in its entirety. To the extent that the foregoing applications and/or any other materials herein incorporated by reference conflict with the present disclosure, the present disclosure controls.

### BACKGROUND

A massively multi-player online game (MMO or MMOG) is a multiplayer video game capable of supporting hundreds, thousands, or millions of simultaneous players. A MMO may be, for example, a role playing game, a first person shooter game, a real-time or turn-based strategy game, a simulation game, a sports game, a casual game, and so on. Game publishers provide a gaming environment via the Internet or other public or private networks, enabling players at personal computers, mobile devices, game consoles, and other client devices to have access to the game.

The emergence of free-to-play (F2P) online games has changed the monetization paradigm for video games from sales of a product (the game itself) to one

The emergence of free-to-play (F2P) online games has changed the monetization paradigm for video games from sales of a product (the game itself) to one of micro-transactions within a game. These in-game purchases may directly impact game balance and game server security, among other things. In fact, many gamers worry that F2P games are in fact P2W (pay-to-win) games, and are often reluctant to play newly introduced games. For example, gamers who believe that a game is P2W are unlikely to continue playing the game, and even less likely to make in-game purchases themselves. Losing garners that would normally spend money within a game introduces many problems in to the F2P model of gaming. Without a consistent player:revenue ratio in the F2P model, losses are borne by dedicated, long-term, and/or high-spending players, by the game publisher, or by all parties involved. Additionally, a F2P game should facilitate garners who do not spend money to play the game, without adversely impacting the other players within the game.

Typically, a MMO is supported by game servers that communicate directly with client devices to provide game play and various third party services to players during the game play. FIG. 1 depicts a conventional computing environment 100 for a MMO. The conventional computing environment 100 includes one or more game servers 110 that host and support game play for the MMO, and communicate with client devices 120 associated with players of the MMO. Typically, the game servers 110 are hardware based servers controlled and/or operated by the provider of the MMO, such as a game publisher. In addition to game play, the conventional computing environment 100 may also provide 3^{rd} party services 115, such as player communication components (e.g., VOIP), game servers 110, store components (e.g., in game stores), and so on, directly via the game servers 110.

Utilizing game provider controlled hardware devices to provide the game play, as well as directly providing 3^{rd} party services via such hardware devices, may lead to various problems and drawbacks associated with providing engaging, entertaining gaming experiences to players of a massively multi-player online game. For example, the game provider may find scalability of the game to be difficult and/or cost inefficient, may encounter issues with providing updated and seamless 3^{rd} party services within a game, among other drawbacks.

Therefore, the need exists for a computing environment and system that overcomes the above problems associated with providing massively multiplayer online games, as well as one that provides additional benefits and features.

### BRIEF DESCRIPTION OF THE FIGURES

FIG. 1 is a block diagram illustrating components of a conventional gaming environment.

FIGS. 2A-2B are block diagrams illustrating a cloud-based computing platform that supports massively multi-player online games.

FIG. 3A is a block diagram illustrating components of a platform manager module.

FIG. 3B is a block diagram illustrating components of a decision engine module.

FIG. 4 is a flow diagram illustrating a routine for providing resources for an online game.

FIG. 5 is a flow diagram illustrating a routine for provisioning cloud-based server instances for an online game.

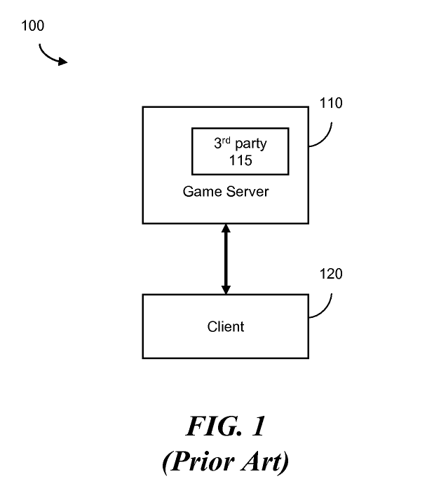

### DETAILED DESCRIPTION

### Overview

A computing platform for providing and/or supporting an online video game, such as a massively multi-player online game (MMO, MMG, MMOG, MMORPG, and so on), is described. The computing platform, in some implementations, is a multi-tenant video game publishing platform designed to reduce complexity in the publishing and operation of online games, as well as deliver various levels of telematic-based modifications, among other things. The computing platform may utilize on-demand computing power from multiple public cloud services vendors (e.g., Amazon's AWS, the Rackspace cloud, Microsoft's Azure, and so on), as well as locally or privately provided cloud services, to provide a scalable, affordable and/or high performance gaming environment, among other benefits. Additionally or alternatively, in some implementations, the computing platform utilizes network performance and geo-location data to optimize game play for a supported MMO.

The computing platform may support various systems and methods utilizing some or all of the features described herein, such as systems and methods that provide a layer of abstraction within a cloud-based gaming platform. For example, in some implementations, the computing platform includes a platform manager module that includes a request component configured to receive requests to access the MMO from client devices associated with players of the MMO, a provisioning component configured to provision one or more cloud-based game instances that provide the MMO to the client devices, and a connection component configured to facilitate direct connections between the client devices and the provisioned cloud-based game instances that provide the MMO.

The computing platform, and associated systems and methods will now be described with respect to various embodiments, examples, and/or implementations. The following description provides specific details for a thorough understanding of, and enabling description for, these embodiments of the platform. However, one skilled in the art will understand that the platform and associated systems and methods may be practiced without these details. In other instances, well-known structures and functions have not been shown or described in detail to avoid unnecessarily obscuring the description of the embodiments of the platform.

The terminology used in the description presented below is intended to be interpreted in its broadest reasonable manner, even though it is being used in conjunction with a detailed description of certain specific embodiments of the platform. Certain terms may even be emphasized below; however, any terminology intended to be interpreted in any restricted manner will be overtly and specifically defined as such in this Detailed Description section.

### The MMO Computing Platform

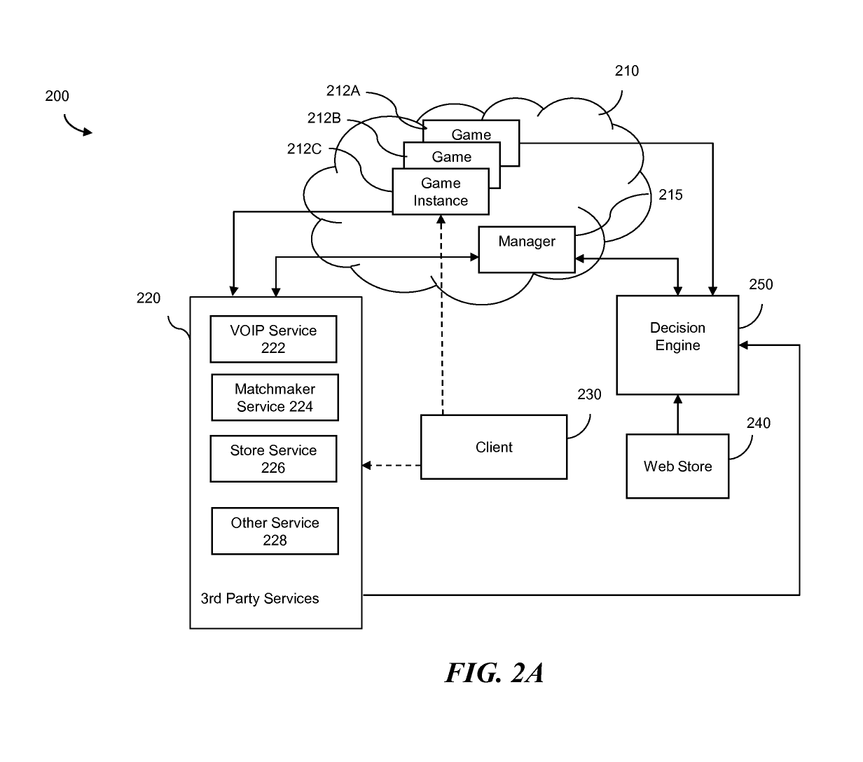

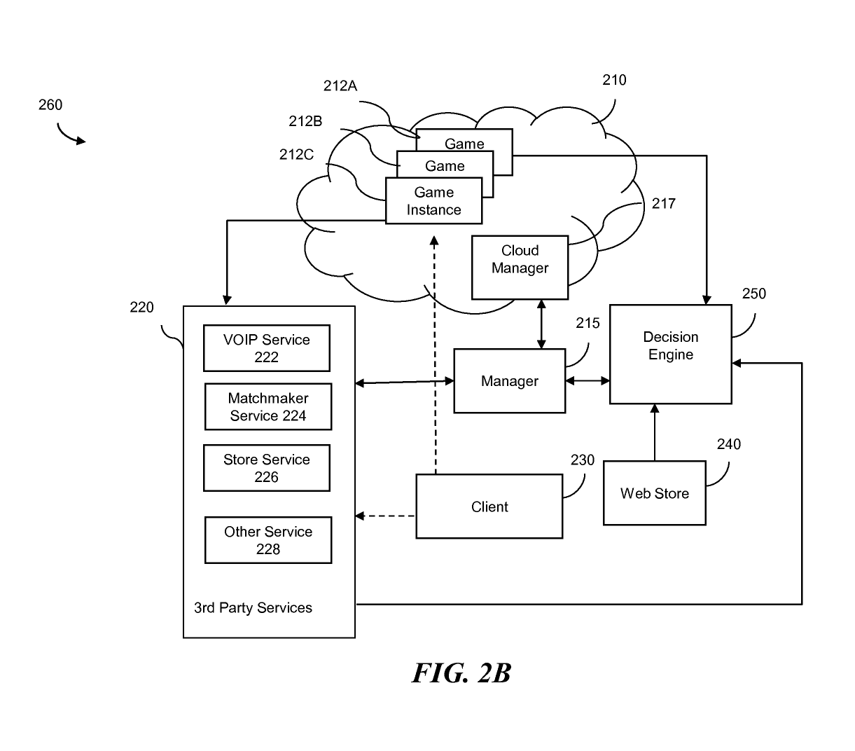

A computing platform that establishes and/or provides a cloud-based, scalable, computing environment in which to support a massively multi-player online game to many users or players located at client devices is described. FIG. 2A depicts various components of such a cloud-based computing platform 200.

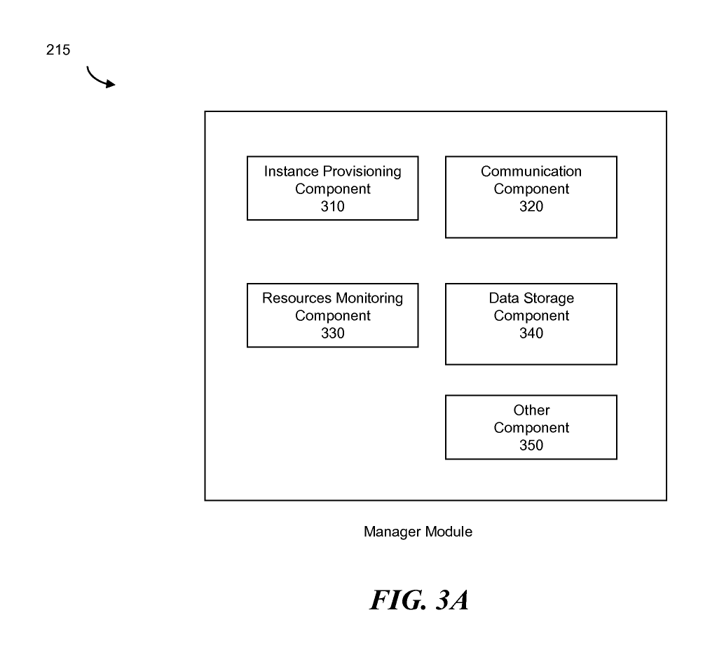

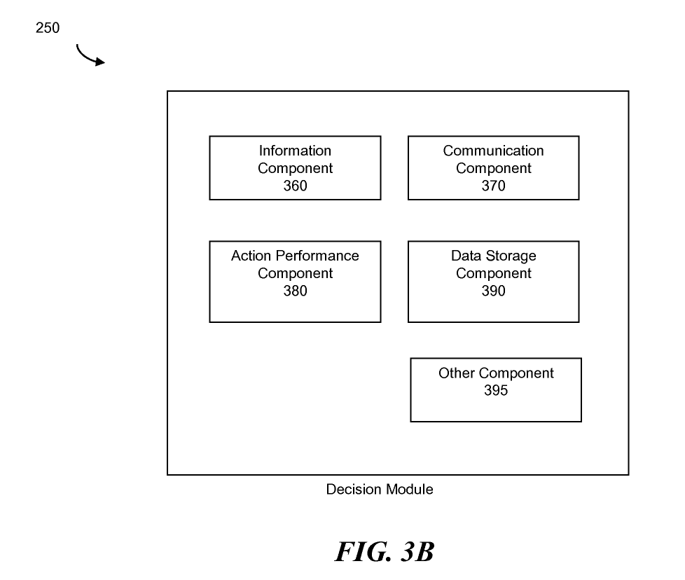

FIGS. 2A-3B and the following discussion provide a brief, general description of a suitable computing environment in which the MMO computing platform and various associated systems and methods can be implemented. Although not required, aspects of the platform are described in the general context of computer-executable instructions, such as routines executed by a general-purpose computer, e.g., a server computer, wireless device, game console, and/or personal computer. Those skilled in the relevant art will appreciate that the system can be practiced with other communications, data processing, or computer system configurations, including: Internet appliances, network PCs, mini-computers, mainframe computers, cloud-based computers, virtual machines, and the like. Indeed, the terms “computer,” “host,” and “host computer” are generally used interchangeably herein, and refer to any of the above devices and systems, as well as any data processor.

Aspects of the computing platform can be embodied in a special purpose computer or data processor that is specifically programmed, configured, or constructed to perform one or more of the computer-executable instructions explained in detail herein. Aspects of the computing platform can also be practiced in distributed computing environments where tasks or modules are performed by remote processing devices, which are linked through a communications network, such as a Local Area Network (LAN), Wide Area Network (WAN), Storage Area Network (SAN), Fibre Channel, or the Internet. In a distributed computing environment, program modules may be located in both local and remote memory storage devices.

Aspects of the computing platform may be stored or distributed on computer-readable media, such as computer-readable storage media, tangible computer-readable media, and/or tangible computer-readable storage media, including magnetically or optically readable computer discs, hard-wired or preprogrammed chips (e.g., EEPROM semiconductor chips), nanotechnology memory, biological memory, or other tangible data storage media. Non-transitory computer-readable media include tangible media such as hard drives, CD-ROMs, DVD-ROMS, and memories such as ROM, RAM, and Compact Flash memories that can store instructions and other storage media. Signals on a carrier wave such as an optical or electrical carrier wave are examples of transitory computer-readable media. Moreover, the computing platform may include computing resources typical of an “Infrastructure as a Service” (IaaS) model, such as resources providing cloud-based virtual machines, servers, storage, load balancing, network architectures, and so on, computing resources typical of a “Platform as a Service” (PaaS) model, such as resources providing run-time computing, databases, web servers, development tools, and so on, and/or computing resources typical of a “Software as a Service” (SaaS) model, such as resources providing CRM, communications, virtual desktops, games, and so on, among other resources. Indeed, computer implemented instructions, data structures, screen displays, and other data under aspects of the computing platform may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the computing platform reside on a server computer, while corresponding portions reside on a client computer, and thus, while certain hardware platforms are described herein, aspects of the system are equally applicable to nodes on a network.

Referring back to FIG. 2A, the computing platform 200 utilizes a cloud-based services computing environment 210 that provisions, establishes, and/or supports one or more game instances 212A-C, each providing a massively multi-player online game and/or various aspects of the MMO. The cloud-based computing environment 210 includes computing resources that facilitate provisioning of the game instances 212A-C to a heterogeneous group of client devices 230 associated with players of the MMO.

For example, the cloud-based computing environment 210 may include computing resources typical of an IaaS model, such as resources providing cloud-based virtual machines, servers, storage, load balancing, network architectures, and so on, computing resources typical of a PaaS model, such as resources providing run-time computing, databases, web servers, development tools, and so on, and/or computing resources typical of an SaaS model, such as resources providing CRM, communications, virtual desktops, games, and so on, among other resources.

The cloud-based computing environment 210 may be formed of a variety of different cloud environments, including a public cloud, a community cloud, a hybrid cloud, a private cloud, an “intercloud,” or any other computing environment capable of and configured to provide infrastructure resources, platform resources, and/or software resources as a service to client devices located within a shared network, among other things.

The game instances 212A-C provide the MMO to client devices 230, such as laptops, smart phones, tablet computers, and so on, associated with players of the MMO, which directly connect and communicate with the instances 212A-C in order to play the game. The client devices 230 may access the game instances 212A-C in a variety of ways, such as via device supported web browsers, game specific software (such as apps downloaded to a device), game console software (such as software running on a PSP, PLAYSTATION, XBOX, NINTENDO game console, etc.) and so on. Thus, in some implementations, users of the client devices 230 directly connect with the game instances 212A-C within the cloud-based computing environment 210 in order to play a game, such as an MMO, that is provided by the game instances 212A-C.

The computing platform 200, in some implementations, also facilitates direct connections between the client devices 230 and services provided by 3^{rd} parties, or 3^{rd} party services 220, within a game. The platform 200 enables client devices to directly access a communication service 222, a store service 224, or other such services 226 associated with a game while playing the game. For example, the computing platform 200 facilitates a player at the client device 230 to access and communicate with other players via a VOIP service 222 while playing a game, without directly providing the VOIP service 222 to the player at the client device 230.

That is, the computing platform 200, in some implementations, provides various uniform APIs to developers of 3^{rd} party services 220 that enable the developers to access a game supported by the game instances 212A-C and provide various services to players at client devices 230. The computing platform 200 facilitates 3^{rd} party vendors to provide various services, such as communication services 222 (e.g., voice, text, chat, and so on), financial services 224 (e.g., storefronts, virtual catalogs, payment facilities, and so on) to players of a game without requiring any direct implementation of such services within the game itself. The computing platform 200 or 260 abstracts the access to game associated services to players at client devices 230 while providing the service providers a flexibility in access, implementation, and/or modification of the services they are providing to players of the game.

Thus, in some implementations, the computing platform 200 or 260 provides a uniform set of APIs to game developers for common components, including economy and item management, game and infrastructure analytics, voice and text communication, and/or matchmaking services. Thus, the game developer is freed from the burden of developing these services themselves, and/or integrating with heterogeneous third-party providers, among other benefits.

Many of the systems and methods described herein are provided by and/or performed by a platform manager module 215, which may be located in the cloud computing environment 210, or elsewhere within the computing platform (see FIG. 2B). The platform manager module 215, in some implementations, facilitates the scaling of the computing platform 200, including the addition and/or removal of game instances 212A-C based on a dynamic view of a gaming environment provided by the game instances 212A-C, among other things.

In some implementations, the platform manager module 215 receives information from a matchmaker service 235, such as a matchmaker service provided by the game publisher, and performs actions based on the received information. A matchmaker service 235 is, among other things, a component within the computing platform 200, often provided by a game publisher, that determines what users to bring together when creating or expanding a game being offered. For example, the matchmaker service 235 may receive a request from a user to join a specific MMO currently being played, identify a suitable point of entry for the user into the game based on information about the user (e.g., the user's location, skill level, historical game play, and so on), and match the user to other users within the currently playing MMO. The platform manager module 215, in some implementations, communicates with the matchmaker service 235 in order to obtain such information and perform various actions, such as actions associated with scaling a game, actions associated with modifying resources supporting the game, and so on. Further details regarding the interactions between the platform manager module 215, including interactions between the matchmaker service 235 and the platform manager module 215, are provided herein.

In some implementations, the platform manager module 215 receives information from a decision engine 250, such as a data driven decision module that is programmed and/or configured to track, obtain, analyze, and make decisions regarding some or all aspects of game supported by the game instances 212A-C, such as information from an associated web store 240, among other things. The platform manager module 215 may then perform actions based on the data provided by the decision engine 250, such as actions associated with adding or removing game instances 212A-C during game play, among other things. Further details regarding the decision engine 250, including interactions between the platform manager module 215 and decision engine 250, are provided herein.

As described herein, in some implementations, the platform manager module 215 may be located outside of the cloud-based computing environment 210, such as at a location associated with or physically proximate to a game publisher that utilized the computing platform described herein to provide an online game. FIG. 2B depicts a computing platform 260 that includes the platform manager module 215 located outside of the cloud-based computing environment 210. The platform manager module 215 may interact with computing resources within the cloud-based computing environment via a cloud manager module 217, which facilitates communications between the platform manager module 215 and various cloud-based and/or cloud supported resources, such as the game instances 212A-C.

The computing platforms 200 and/or 260 facilitate many different flows of data or other information between components, as shown by the arrows in the Figures. For example, in some implementations:
game play data (e.g., play instructions) may flow from client devices 230 to game instances 212A-C and/or to 3^{rd} party services;
information generated within the game instances 212A-C may flow to the decision engine 250, the 3^{rd} party services 220, the platform manager module 215, or elsewhere;
information generated by the 3^{rd} party services 220, the web store 240, the platform manager 215, the game instances 212A-C, or elsewhere, may flow to the decision engine 250;
information may flow from the platform manager module 215 to the decision engine 250, and from the decision engine 250 to the platform manager module 215;
information may flow between the platform manager module 215 and the 3^{rd} party services 220; and/or
information may flow between the matchmaker service 235 and the client devices 230, between the matchmaker service 235 and the platform manager module 215, and/or between the matchmaker service 235 and the game instances 212A-C; and so on.

Of course, one of ordinary skill in the art will realize that the computing platform 200 may facilitate the flow of information and/or data between other components and/or resources not specifically described herein.

The computing platform 200 or 260 may provide publically available services wrapped with a web services API. Such services may be accessed from a client or server, as well as any web properties surrounding a game. In some cases, the platform is resource-oriented, with each service responsible for managing its own persistence layer. For example, the services may expose an API accessible by any HTTPS client. Clients and servers mutually authenticate each other, when necessary, using industry standard SSL certificates. In some cases, clients and servers communicate using both the HTTP layer protocol (headers, and so on) and the entity body (request/response payload). Entity bodies may be JSON-encoded, and adhere to a common format across services. That is, services requests may be simple HTTP requests, where a HTTP verb dictates the type of operation being performed upon a specified resource. For example, any method-specific additional parameters may be included as query string parameters concatenated to a request URL.

As described herein, the platform manager module 215 may act as a layer of abstraction between the resources providing game play (e.g., game instances 212A-C) and client devices that enable users to play a game. The platform manager module 215, in some implementations, includes various components configured and/or programmed to facilitate the performance of various actions within the computing platform 200.

FIG. 3A depicts components of the platform manager module 215. In some implementations, the platform manager module 215 includes an instance provisioning component 310 configured and/or programmed to perform actions that cause the cloud-based computing environment 210 to add, remove, and/or otherwise modify the number, amount, and/or provisioning of cloud-based game servers, such as game instances 212A-C, utilized to provide a game to client devices 230. For example, the instance provisioning component 310 may provide instructions to the cloud-based computing environment 210 to launch and provision an additional game instance 212C when game play information identifies a need for additional supporting resources.

In some implementations, the platform manager module 215 includes a communication component 320 configured and/or programmed to facilitate communication between the platform manager module 215 and other components within the computing platform 200 or 260.

In some implementations, the platform manager module 215 includes a resources monitoring component 330 configured and/or programmed to track and/or monitor the operation of some or all of the resources within the computing platform 200 or 260. For example, the resources monitoring component 330 may monitor game play statistics associated with game instances 212A-C, may monitor users associated with a matchmaker service 235, and/or perform other telematics within the computing platform 200 or 260. The platform manager module 215 may also include a data storage component 340, such as various databases and/or memory, that store data associated with game play, computing platform resources and/or components, performed actions, data analyses, and so on.

The platform manager module 215 may also include other components 350, such as components that perform various different actions within the computing platform 200 or 260, components that determine and/or decide actions to be performed, components that generate reports, components that provide various load balancing or optimization of resources, and so on.

In some implementations, the platform manager module 215 receives information from the decision engine 250, and performs actions based on such information. FIG. 3B depicts components of the decision engine 250. In some implementations, the decision engine 250 includes an information component 360 configured and/or programmed to track, monitor, extract, and/or obtain data and other information from the computing platform 200 or 260. For example, the information component 360 may obtain information associated with a number of users playing a game, a number of game instances providing a game, telematics associated with the game or computing resources providing the game, a current cost to provide a game, and so on.

In some implementations, the decision engine includes a communication component 370 configured and/or programmed to facilitate communication between the decision engine 250 and other components within the computing platform 200 or 260.

In some implementations, the decision engine includes an action performance component 380 configured and/or programmed to perform various actions within the computing platform 200 or 260. For example, the action performance component 380 may cause the manager module 215 to add or remove a game instance based on information obtained by the information component 360.

The decision engine 250 may also include a data storage component 390, such as various databases and/or memory, that store data associated with game play, computing platform resources and/or components, performed actions, data analyses, and so on. The decision engine 250 may also include other components 395, such as components that determine and/or decide actions to be performed, components that generate reports, components that provide various load balancing or optimization of resources, and so on.

Thus, in some implementations, the computing platform 200 or 260 provides a cloud-based gaming environment which provides a layer of abstraction for users of the platform. The abstraction layer, facilitated by a platform manager module 215, enables the computing platform to scale its resources when needed, providing a cost efficient yet powerful computing environment in which to host an online game, such as a massively multi-player online game, among other benefits.

Further details regarding routines and/or techniques performed by resources within the computing platforms 200 and 260, such as routines and/or techniques performed by the platform manager module 215 or the decision engine 250, will now be described.

### Scalability of Computing Resources in a Gaming Environment

As described herein, in some implementations, the computing platform 200 or 260 provisions computing resources, such as cloud-based server instances, within a gaming environment, which facilitates a scalable, flexible computing environment in which to host an online game, such as a massively multi-player online game, among other benefits.

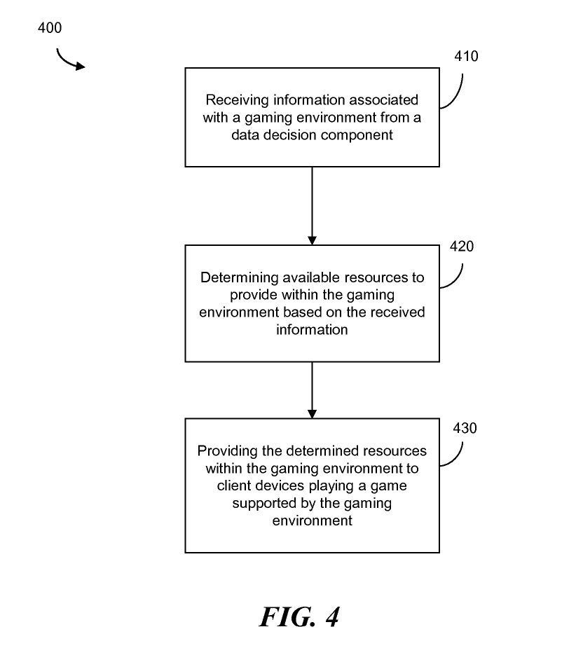

FIG. 4 is a flow diagram illustrating a routine 400 for providing resources for an online game. In step 410, the platform receives information associated with a gaming environment. For example, the platform, via the platform manager module 215, receives information from the decision engine 250, such as information associated with a number of players within the game.

The decision engine 250 obtain and provide various types of information associated with a game, such as information associated with current, predicted, and/or historical operation of computing resources, information associated with load balancing within the platform, information associated with costs for utilizing the computing resources providing the online game, information associated with locations of resources with respect to locations of players within the online game, and so on.

In step 420, the platform determines available resources to be provided based on the received information. For example, the platform, via the instance provisioning component 310, determines what resources should be provisioned for use and/or removed from use within the gaming environment.

That is, the platform manager module 215 may receive information from the decision engine 250 identifying an increase in the number of players at a certain geographical location, and determine that a cloud-based server instance proximate to that certain geographical location should be provisioned to provide the online game to the players at that location.

In step 430, the platform provides the determined resources within the gaming environment to client devices playing the online game supported by the gaming environment. For example, the platform, via the instance provisioning component 310, provisions the resources determined to be necessary to provide the online game to players at client devices.

In some example, the platform may provide various different types of resources, cloud-based or otherwise, including game or server instances, data communication resources, data transmission resources, and so on. The platform may add resources, remove resources, adjust the use or provisioning of resources, and so on. That is, the platform may utilize information about a gaming environment and adjust how and with what resources the platform provides the gaming environment to players, among other benefits.

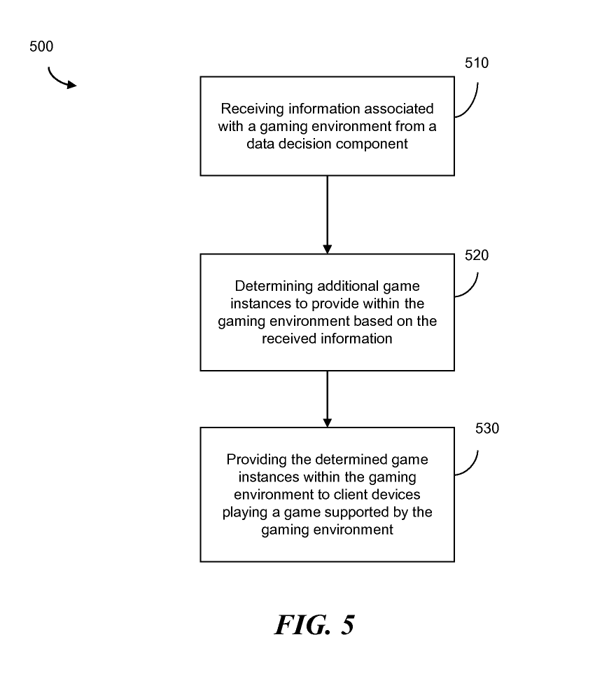

In some examples, the platform facilitates a flexible, intelligent utilization of cloud-based game instances that provide an online game to players at client devices. FIG. 5 is a flow diagram illustrating a routine 500 for provisioning cloud-based server instances for an online game.

In step 510, the platform receives information associated with a gaming environment from a data decision component, such as the decision engine 250. For example, the platform, via the platform manager module, receives information identifying an increasing or decreasing number of players playing a game over a certain time period.

In step 520, the platform determines additional game instances to provide within the gaming environment based on the received information. For example, the instance provisioning component 310 determines a number of game instances to remove and/or provision as well as what specific game instances to remove and/or provision, based on the received information.

In step 530, the platform provides the determined game instances within the gaming environment to client devices playing the online game supported by the gaming environment. For example, the platform, via the instance provisioning component 310 removes and/or provisions the determined game instances providing or to be providing the online game to players.

That is, the platform, in some examples, is capable of scaling the use of game instances providing an online game based on the monitoring of information associated with the online game. As described herein, the platform may add or remove game instances based on various different types of information, such as:
information identifying a number of players, active or otherwise, currently playing a game;
information identifying a predicted number of players, active or otherwise, expected to play a game;
information identifying a historical number of players, active or otherwise, that played the game during a certain related time period
information identifying a cost for providing a game, such as a cost metric identifying a cost/user/time period for a currently running game;
information identifying a predicted cost for providing a game, such as a predicted cost for a current or future time period;
information received from a service supported by the game, such as a matchmaker service or a third party service; and so on.

Thus, by monitoring game play and other information associated with play of an online game, the layer of abstraction managing an online game supported by the computing platform may facilitate the scaling of server instances and other resources in order to efficiently and cost effectively provide the online game to players, among other benefits.

### CONCLUSION

Thus, in some implementations, the technology described herein provides a publishing platform that enables video game development houses to publish online games without relying on costly capital expenditures for technology infrastructure and complex third-party service integration, while still having enabling a game to scale to 100,000+ concurrent players.

From the foregoing, it will be appreciated that specific examples and implementations of the technology have been described herein for purposes of illustration, but that various modifications may be made without deviating from the spirit and scope of the technology. Accordingly, the system is not limited except as by the appended claims.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the technology is not intended to be exhaustive or to limit the system to the precise form disclosed above. While specific embodiments of, and examples for, the technology are described above for illustrative purposes, various equivalent modifications are possible within the scope of the system, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the technology provided herein can be applied to other systems, not necessarily the technology described above. The elements and acts of the various embodiments described above can be combined to provide further embodiments.

These and other changes can be made to the s technology in light of the above Detailed Description. While the above description details certain embodiments of the system and describes the best mode contemplated, no matter how detailed the above appears in text, the system can be practiced in many ways. Details of the technology may vary considerably in implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the system to the specific embodiments disclosed in the specification, unless the above Detailed Description section explicitly defines such terms. Accordingly, the actual scope of the system encompasses not only the disclosed embodiments, but also all equivalent ways of practicing or implementing the system under the claims.

While certain aspects of the technology are presented below in certain claim forms, the inventors contemplate the various aspects of the technology in any number of claim forms. Accordingly, the inventors reserve the right to add additional claims after filing the application to pursue such additional claim forms for other aspects of the technology.

We claim:

1. A cloud-based gaming platform, comprising:
a platform manager module, wherein the platform manager module is configured to add or remove cloud-based computing resources providing an online game to players at client devices based on information associated with the online game; and
an information module, wherein the information module is configured to provide the information associated with the online game to the platform manager module.

2. The cloud-based gaming platform of claim 1, wherein the information module is configured to monitor the online game and provide information associated with a number of players playing the online game to the platform manager module.

3. The cloud-based gaming platform of claim 1, wherein the information module is configured to monitor the online game and provide information associated with a predicted number of players playing the online game to the platform manager module.

4. The cloud-based gaming platform of claim 1, wherein the information module is configured to monitor the online game and provide information associated with a predicted number of resources required to provide the online game to the platform manager module.

5. The cloud-based gaming platform of claim 1, wherein the information module is configured to monitor the online game and provide information associated with a cost of the computing resources providing the online game to the platform manager module.

6. The cloud-based gaming platform of claim 1, wherein the information module is configured to monitor the online game and provide information associated with a predicted number of resources required to provide the online game and a predicted location of the resources required to provide the online game to the platform manager module.

7. The cloud-based gaming platform of claim 1, wherein the information module is configured to monitor the online game and provide information associated with a geographical location of players playing the online game to the platform manager module.

8. A method for provisioning computing resources to a gaming platform, the method comprising:
receiving information associated with an online game running on a gaming platform; and
adding at least one additional computing resource to the gaming platform based on the received information.

9. The method of claim 8, wherein receiving information associated with an online game running on a gaming platform includes receiving information identifying a number of players playing the online game, and wherein adding at least one additional resource to the gaming platform based on the received information includes selecting a computing resource based on a geographical location of the players playing the online game.

10. The method of claim 8, wherein receiving information associated with an online game running on a gaming platform includes receiving information identifying a number of players predicted to play the online game, and wherein adding at least one additional resource to the gaming platform based on the received information includes selecting a computing resource based on a geographical location of the players playing the online game.

11. The method of claim 8, wherein receiving information associated with an online game running on a gaming platform includes receiving information identifying a cost to provide the online game, and wherein adding at least one additional resource to the gaming platform based on the received information includes selecting a computing resource based on a cost of the resource.

12. A computer-readable storage medium whose contents, if executed by a processor of a computing device, cause the computing device to perform a method for terminating use of a computing resource providing an online game to players at client devices, the method comprising:
receiving information associated with a currently playing online game; and
selecting a computing resource providing the online game to terminate based on the received information.

13. The computer-readable storage medium of claim 12, wherein the selected computing resource is a cloud-based server instance providing the online game.

14. The computer-readable storage medium of claim 12, wherein selecting the computing resource providing the online game to terminate based on the received information includes selecting a computing resource based on a geographical location of the computing resource.

15. The computer-readable storage medium of claim 12, wherein selecting the computing resource providing the online game to terminate based on the received information includes selecting a computing resource based on a cost of the computing resource.

16. A cloud-based gaming platform, comprising:
a platform manager module, wherein the platform manager module is configured to add or remove cloud-based server instances providing an online game to players at client devices based on information associated with the online game; and
an information module, wherein the information module is configured to provide the information associated with the online game to the platform manager module.

17. The cloud-based gaming platform of claim 16, wherein the information module is configured to monitor the online game and provide information associated with a number of players playing the online game to the platform manager module.

18. The cloud-based gaming platform of claim 16, wherein the information module is configured to monitor the online game and provide information associated with a predicted number of players playing the online game to the platform manager module.

19. The cloud-based gaming platform of claim 16, wherein the information module is configured to monitor the online game and provide information associated with a predicted number of server instances required to provide the online game to the platform manager module.

20. The cloud-based gaming platform of claim 16, wherein the information module is configured to monitor the online game and provide information associated with a cost of the server instances providing the online game to the platform manager module.

21. The cloud-based gaming platform of claim 16, wherein the information module is configured to monitor the online game and provide information associated with a predicted number of server instances required to provide the online game and a predicted location of the resources required to provide the online game to the platform manager module.

22. The cloud-based gaming platform of claim 16, wherein the information module is configured to monitor the online game and provide information associated with a geographical location of server instances providing the online game to the platform manager module.

23. A method for provisioning game instances within a gaming platform, the method comprising:
receiving information associated with an online game running on a gaming platform; and
adding at least one game instance to the gaming platform based on the received information.

24. The method of claim 23, wherein receiving information associated with an online game running on a gaming platform includes receiving information identifying a number of players playing the online game, and wherein adding at least one game instance to the gaming platform based on the received information includes selecting a game instance based on a geographical location of the players playing the online game.

25. The method of claim 23, wherein receiving information associated with an online game running on a gaming platform includes receiving information identifying a number of players predicted to play the online game, and wherein adding at least one game instance to the gaming platform based on the received information includes selecting a game instance based on a geographical location of the players playing the online game.

26. The method of claim 23, wherein receiving information associated with an online game running on a gaming platform includes receiving information identifying a cost to provide the online game, and wherein adding at least one game instance to the gaming platform based on the received information includes selecting a game instance based on a cost of the game instance

27. A computer-readable storage medium whose contents, if executed by a processor of a computing device, cause the computing device to perform a method for terminating use of a cloud-based server instance providing an online game to players at client devices, the method comprising:
receiving information associated with a currently playing online game; and
selecting a server instance providing the online game to terminate based on the received information.

28. The computer-readable storage medium of claim 27, wherein selecting the server instance providing the online game to terminate based on the received information includes selecting the server instance based on a geographical location of the server instance.

29. The computer-readable storage medium of claim 27, wherein selecting the server instance providing the online game to terminate based on the received information includes selecting the server instance based on a cost of the server instance.
